(19) United States
(12) Patent Application Publication
(10) Pub. No.: US 2016/0291678 A1
(43) Pub. Date: Oct. 6, 2016

(54) POWER REDUCTION IN BUS INTERCONNECTS

(71) Applicant: Advanced Micro Devices, Inc., Sunnyvale, CA (US)

(72) Inventors: Greg Sadowski, Boxborough, MA (US); John Kalamatianos, Boxborough, MA (US)

(73) Assignee: ADVANCED MICRO DEVICES, INC., Sunnyvale, CA (US)

(21) Appl. No.: 14/672,722

(22) Filed: Mar. 30, 2015

(51) Int. Cl. G06F 1/32; G06F 13/16; G06F 12/08

(52) U.S. Cl. CPC G06F 1/3253; G06F 12/0877; G06F 12/0895; G06F 13/1673; G06F 13/1642; G06F 1/3287; G06F 2212/1028; G06F 2212/603

(57) ABSTRACT

In one form, power consumed in transmitting data over a bus interconnect is reduced. The power is reduced by configuring a buffer that is used to store data to be transmitted over the bus interconnect as a two-dimensional (2D) buffer array having a plurality of rows and columns. The data stored in the 2D buffer array is then analyzed to determine a mode of transmitting the data that uses a least amount of power. The determined mode is used to transmit the data over the bus interconnect.

### FIELD

This disclosure relates generally to data processing systems, and more specifically to power reduction in bus interconnects of data processing systems.

### BACKGROUND

Today's laptops, notebooks, smart phones, tablets, etc. contain system-on-chip (SoC) components that are implemented using ultra deep submicron (UDSM) very large scale integration (VLSI) technology. Devices that are implemented using UDSM VLSI technology are high density micro-electronic devices. Due to being high density micro-electronic devices, controlling the amount of power consumed by these devices has become a critical concern.

Particularly, based on the power consumption of these SoC devices, battery life of batteries used by mobile computing systems incorporating these devices may be prolonged and operational use of the mobile computing systems may be increased before there is a need for a battery recharge. In addition, cooling requirements, noise and operating cost of systems incorporating these SoC devices may all be reduced. Further, heat dissipation in the devices may be reduced, which may result in an increased in device and system stability.

In any event, two or more functional blocks within a SoC device may exchange data with each other over a bus interconnect. Further, two different SoC devices in a computing system may also exchange data with each other over a bus interconnect. Thus, SoC devices may have a plurality of different bus interconnects that may be used to transmit data from one location to another of a computing system. Bus interconnects consume power to transfer data. Consequently, lowering the amount of power that may be expended to transmit data over the different bus interconnects of a SoC device may lower the power consumed by the SoC device; and hence, the power consumed by a computing system incorporating the SoC devices.

### BRIEF DESCRIPTION OF THE DRAWINGS

FIG. 1 depicts a block diagram of a computing system implemented in accordance with an embodiment of the disclosure.

FIG. 2 illustrates a block diagram representation of an accelerated processing unit (APU) used in the computing system of FIG. 1.

FIG. 3 depicts a block diagram of a bus interface of two devices in the computing device of FIG. 1 that may exchange data over a bus interconnect.

FIG. 4(a) depicts a block diagram of a transmitter controller using an N×N buffer array to transmit data to a receiver controller in the computing system of FIG. 1.

FIG. 4(b) depicts a block diagram of a transmitter controller using an N×N×N buffer array to transmit data to a receiver controller in the computing system of FIG. 1.

FIG. 5 depicts a flow diagram of a process that may be used by a transmitter of a controller servicing a transmitting device to transmit data to a receiver of a controller servicing a receiving device of the computing system of FIG. 1, according to some embodiments.

FIG. 6 depicts a flow diagram of a process that may be used by a receiver of a controller servicing a receiving device to reproduce data transmitted by a transmitter of a controller servicing a transmitting device of the computing system of FIG. 1, according to some embodiments.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

In one form, the present disclosure provides a method of reducing dynamic power consumption in a bus interconnect when data is being transmitted over the bus interconnect. The method includes configuring a buffer that is used to store the data as a two-dimensional (2D) buffer array having a plurality of rows and columns. The data stored in the 2D buffer array is analyzed to determine a mode of transmitting the data that uses a least amount of power. The determined mode is then used to transmit the data.

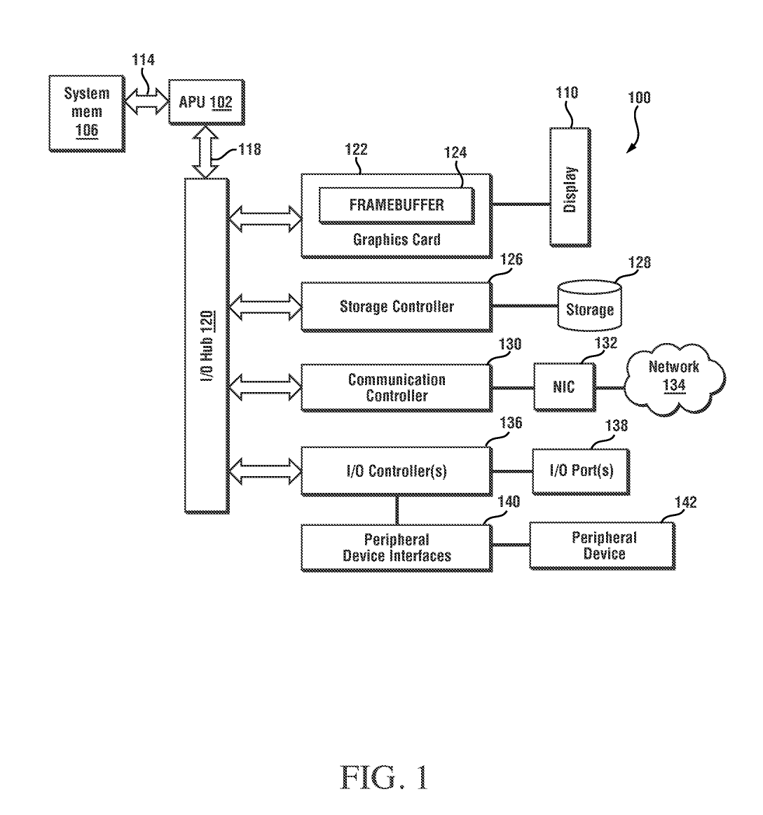

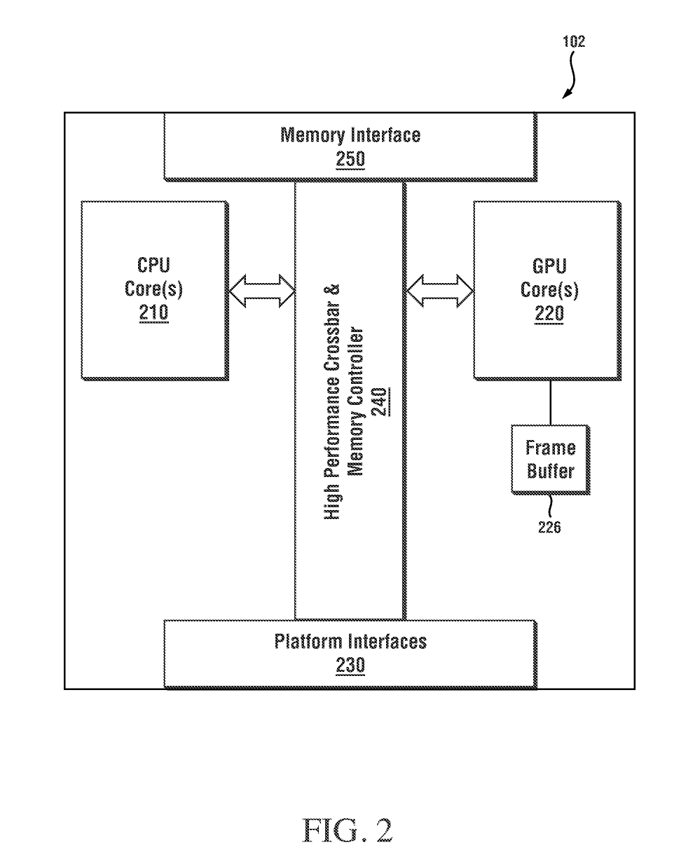

With reference now to the figures, FIG. 1 depicts a block diagram of a computing system 100 implemented in accordance with an embodiment of the disclosure. The computing system 100 includes at least one accelerated processing unit (APU) 102. APU 102, as shown in FIG. 2, may include one or more central processing unit (CPU) cores 210 and one or more graphic processing unit (GPU) cores 220. The one or more CPU cores 210 may be used to process data that is best processed in series while the one or more GPU cores 220 may be used to process data that is to be processed in parallel. Both the one or more CPU cores 210 and GPU cores 220 are connected to a high performance crossbar and memory controller 240. The high performance crossbar and memory controller 240 may be connected to an off-chip system memory (not shown) via a memory interface 250. The high performance crossbar and memory controller 240 is also connected to platform interface 230. Platform interface 230 provides an interface through which other devices in a computer system may be attached to the APU 102.

The one or more CPU cores 210 and the one or more GPU cores 220 may each be connected to at least one memory management unit or MMU (not shown). The at least one MMUs may provide virtual to physical memory address translations as well as protection functionalities for the one or more CPU cores 210 and GPU cores 220. Further, the at least one MMUs may support a unified memory address space allowing for the integration of the one or more CPU cores 210 and GPU cores 220 into one processing chip in accordance with a heterogeneous system architecture (HSA).

The one or more GPU cores 220 may also be connected to a frame buffer 226. Frame buffer 226 is used to hold a complete bit-mapped image that is to be sent to a display device (not shown). Frame buffer 226 may be part of system memory or part of a video adapter.

Returning to FIG. 1, APU 102 is connected over link 114 to system memory 106 via memory interface 250 of FIG. 2. System memory 106 may include one or more dynamic random access memory (DRAM) devices, non-volatile RAM (NVRAM) devices, or any other type of memory device that may be used as system memory or a combination thereof.

APU 102 is also connected to an input/output (I/O) hub 120 over link 118 through platform interface 230 of FIG. 2. I/O hub 120 provides a platform through which various peripheral or I/O devices may be connected to the computing system 100. For example, display device 110 is connected to the computing system 100 via a video adapter or graphics card 122 attached to I/O hub 120. The external graphics card 122 may contain an integrated frame buffer 124 that may be used to hold complete bit-mapped images that are to be sent to display device 110. In computing systems that do not include an external graphics card 122, frame buffer 226 of FIG. 2 may be used to hold the complete bit-mapped images that are to be displayed on display device 110.

Storage device 128, which may include hard drives, NVRAMs, flash drives etc., may also be connected to the computing system 100 via storage controller 126 attached to I/O hub 120. Storage device 128 may contain user data, at least one operating system (OS), a hypervisor in cases where the computing system 100 is logically partitioned, as well as software applications that may be needed by the computing system 100 to perform any particular task. In operation, the OS, hypervisor, firmware applications and the software application needed by the computing system 100 to perform a task may all be loaded into system memory 106.

The computing system 100 may include a network interface card (NIC) 132. NIC 132 is attached to I/O hub 120 through communication controller 130. The computing system 100 may use NIC 132 to interact with other computing systems over network 134. Network 134 may include connections, such as wire, wireless communication links, fiber optic cables, etc. Further, network 134 may include the Internet or may be implemented as a number of different types of networks, such as for example, an intranet, a local area network (LAN), a wide area network (WAN), a cellular phone network etc.

Computing system 100 may also include one or more I/O controllers 136 attached to I/O hub 120. The one or more I/O controllers 136 may support connection by and processing of signals from one or more connected input device(s), such as a keyboard, mouse, touch screen, camera, microphone etc. (all not shown). The one or more I/O controllers 136 may also support connection to and forwarding of output signals from one or more connected output devices. The one or more connected output devices may also include audio speaker(s), printer(s) etc. (all not shown). The one or more input and output devices may be connected to the computing system 100 through one or more I/O ports 138.

Additionally, in one or more embodiments, one or more peripheral device interfaces 140 may be attached to the computing system 100 via the one or more I/O controllers 136. The one or more peripheral device interfaces 140 may support an optical reader, a universal serial bus (USB), a card reader, Personal Computer Memory Card International Association (PCMCIA) slot, and/or a high-definition multimedia interface (HDMI). The one or more peripheral device interfaces 140 may be utilized to enable data to be read from or stored to one or more peripheral devices 142. The one or more peripheral devices 142 may include removable storage devices, such as compact disks (CDs), digital video disks (DVDs), flash drives, or flash memory cards. The one or more peripheral device interfaces 140 may further include General Purpose I/O interfaces such as I2C, SMBus, and peripheral component interconnect (PCI) buses.

In operation, each I/O device attached to the computing system 100 may exchange data with system memory 106 using a respective controller. For example, storage device 128 and NIC 132 use storage controller 126 and communication controller 130, respectively, while one or more I/O devices attached to the one or more ports 138 and/or one or more peripheral devices 142 use the one or more I/O controllers 136 to exchange data with system memory 106.

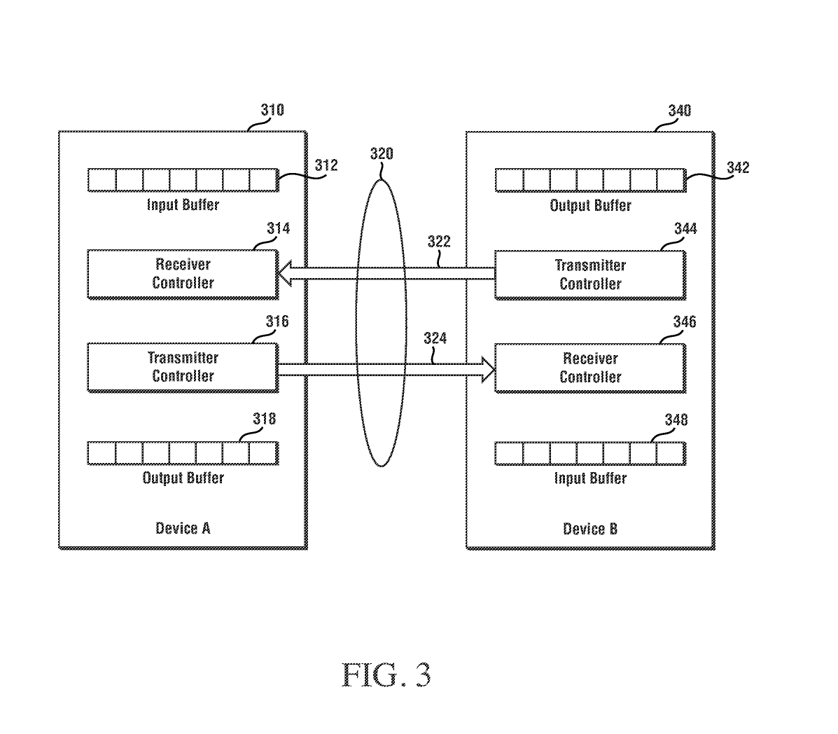

FIG. 3 depicts a block diagram of a bus interface of two devices in the computing device of FIG. 1 that may exchange data over a bus interconnect 320. The two devices include device A with a bus interface 310 and device B with a bus interface 340. Device A may represent a controller servicing any one of the I/O devices connected to the computing system 100 and device B may represent high performance crossbar and memory controller 240 of FIG. 2 that services system memory 106 of FIG. 1.

Bus interconnect 320 may be a HyperTransport™ link and may range from 2 to 32 bits per link. HyperTransport™ is a trademark of the HyperTransport™ Industry Consortium. Further, bus interconnect 320 may represent link 118 of FIG. 1 and includes two unidirectional links (i.e., unidirectional links 322 and 324). Thus, in cases where bus interconnect 320 is 16-bit wide, unidirectional links 322 and 324 are each 8-bit wide. Consequently, unidirectional links 322 and 324 may each include 8 wires and allow for the simultaneous transmission of 8 bits of data in both directions (i.e., in parallel).

In any event, bus interface 310 includes an input buffer 312, a receiver controller 314, a transmitter controller 316 and an output buffer 318. Bus interface 340 includes an input buffer 348, a receiver controller 346, a transmitter controller 344 and an output buffer 342. Transmitter controller 316 may use output buffer 318 to temporarily store data that is being transmitted by the transmitting device. The data may temporarily be stored in output buffer 318 so that transmitter controller 316 may process the data before transmitting the data. After processing the stored data, transmitter controller 316 may transmit the data from output buffer 318 to receiver controller 346 over unidirectional link 324. The received data may temporarily be stored in input buffer 348 allowing for receiver controller 346 to process the data before forwarding the data to the receiving device. Likewise, transmitter controller 344 of bus interface 340 may temporarily store data to be transmitted to receiver controller 314 in output buffer 342. There, the data may be processed by transmitter controller 344 and transmitted to receiver controller 314 over unidirectional link 322. The received data may temporarily be stored in input buffer 312 before being forwarded to the receiving device.

As is well known in the field, two main sources of power dissipation in buses are data transitions in the wires of the buses and coupling between adjacent wires of the buses (i.e., crosstalk). Data transitions occur when different bit or signal values are successively transmitted on a wire (i.e., 1→0 or 0→1). The power dissipated to transition or toggle signals on a wire of a bus is referred to as dynamic power. Most of the dynamic power consumed by a bus interconnect stems from logic gate activities in the bus interconnect. When logic gates toggle, energy is dissipated as capacitors inside the logic gates are charged and discharged etc.

Crosstalk is any phenomenon by which a signal transmitted on a wire creates an undesired effect, such as noise or voltage fluctuations etc., in signals transmitted on adjacent wires. Data transitions on two adjacent wires may lead to crosstalk by charging and discharging coupling capacitances between the two adjacent wires. This leads to increased energy dissipation.

Consequently, lowering the number of data transitions that may occur in the wires of a bus interconnect during data transmission lowers the amount of power that may be consumed by the bus interconnect in transferring the data. More specifically, reducing the number of data transitions in the bus reduces the dissipated dynamic power by the bus not only because the switch capacitances of each wire are charged and discharged less often but also because less dynamic power is dissipated charging and discharging coupling capacitances between adjacent wires.

In accordance with the present disclosure, to reduce the number of data transitions that may occur on wires of a bus interconnect during data transmissions, the input and output buffers 312, 318, 342 and 348 may first be configured as two-dimensional (2D) N×N buffer arrays, where N is any positive integer. In cases where unidirectional links 322 and 324 are 8-bit wide, N may be eight (8). The output N×N buffer arrays 318 and 342 may then be filled up with data to be transmitted. Once the output N×N buffer arrays 318 and 342 are filled up with data, then it may be determined how best to transfer the data such that a least amount of dynamic power is used in doing so.

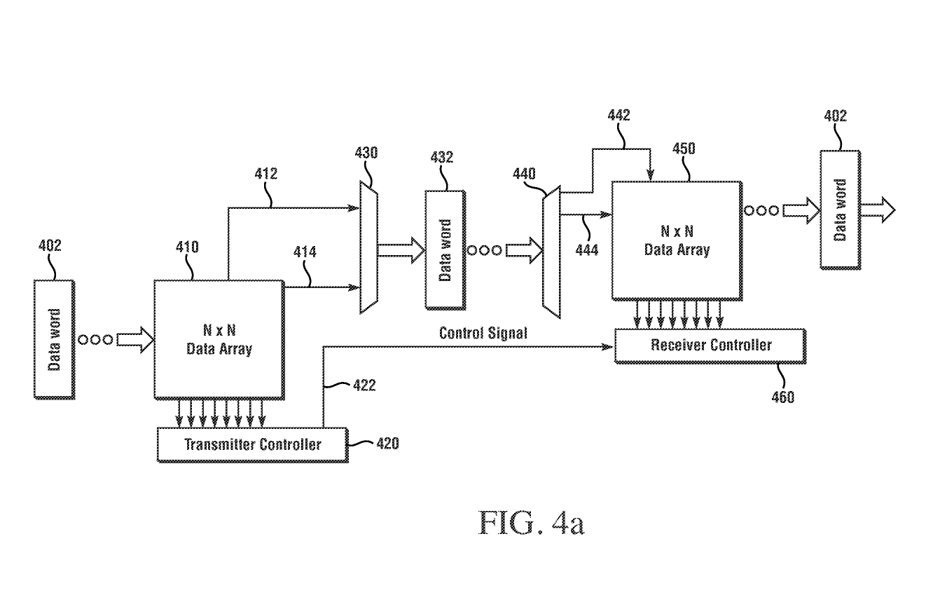

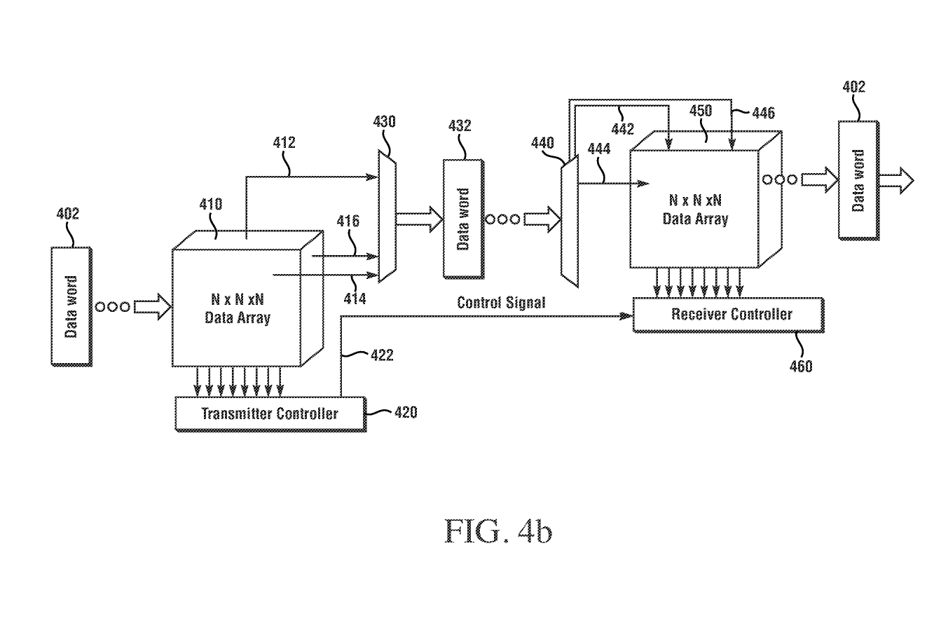

FIG. 4(a) depicts a block diagram of a transmitter controller 420 using an N×N buffer array 410 to transmit data to a receiver controller 460 in the computing system of FIG. 1. In this figure, dataword 402 represents data from a transmitting device. Specifically, data from a transmitting device may be divided in chunks large enough to fit in rows and/or columns of N×N buffer array 410. In this case, since N is eight (8), an 8-bit dataword is used (i.e., 8-bit chunks of data are used). The transmitting device may be system memory 106, when memory device is transmitting data to an I/O device, or an I/O device when the I/O device is transmitting data to system memory 106. When the transmitting device is system memory 106, transmitter controller 420, N×N data array 410, receiver controller 460 and N×N data array 450 represent transmitter controller 344, output buffer 342, receiver controller 314 and input buffer 312, respectively, of FIG. 3. Conversely, when the transmitting device is an I/O device, transmitter controller 420, N×N data array 410, receiver controller 460 and N×N data array 450 represent transmitter controller 316, output buffer 318, receiver controller 346 and input buffer 348, respectively, of FIG. 3.

Each dataword 402 from the transmitting device is written into a column of N×N data array 410. When N×N data array 410 is filled up with data, transmitter controller 420 analyzes the data in N×N data array 410 to determine which mode of transmitting the data may yield the least amount of dynamic power consumption in bus interconnect 320 of FIG. 3 (e.g., least number of bit transitions in the wires of the bus). The mode may be to send the data one column at a time or one row at a time. If transmitting the data one column at a time from N×N data array 410 will result in the least amount of dynamic power consumed by bus interconnect 320, data line 414 is used to load a column of N×N data array 410 into multiplexer 430. Further, transmitter controller 420 uses control signal line 422 to notify receiver controller 460 that the data will be sent one column at a time. In this case, a bit value of zero (0) sent over the control signal line 422 may indicate that the data is being sent one column at time and a bit value of one (1) may indicate that the data is being sent one row at a time or vice versa. Thus, each column is successively loaded into multiplexer 430 and transferred as dataword 432 to demultiplexer 440 until all data in N×N data array 410 is transferred to receiver controller 460. While receiving the datawords 432, the receiver controller 460, based on the notification received on control signal line 422, uses data line 444 to write each dataword 432 from demultiplexer 440 into a column of N×N data array 450.

If, on the other hand, transmitting the data one row at a time from N×N data array 410 will result in the least amount of dynamic power consumed by bus interconnect 320, data line 412 is used to load each row into multiplexer 430. As previously mentioned, transmitter controller 420 will notify receiver controller 460 that the data is being sent one row at a time using control signal line 422. Each row is successively loaded into multiplexer 430 and transferred as dataword 432 to demultiplexer 440 until all data in N×N data array 410 is transferred to receiver controller 460. As the data is being received by receiver controller 460, the receiver controller, based on the notification from control signal line 422, uses data line 442 to write each transferred dataword 432 into a row of N×N data array 450.

In either case, when N×N data array 450 is filled up with data, receiver controller 460 reproduces each dataword 402 in the sequence transmitted by the transmitting device from N×N data array 450. Receiver controller 460 then transfers each reproduced dataword 402 to the receiving device.

Note that, in this particular case, data may by default be written into N×N data arrays 410 and 450 from left-to-right when data is written therein one column at a time or top-to-bottom when data is written therein one row at a time. However, the disclosure is not thus restricted. For example, N×N data arrays 410 and 450 may be filled up from right-to-left or bottom-to-top or from any particular column or row to any other particular column or row etc., so long as receiver controller 460 is aware of the manner used by transmitter controller 420 to write each dataword 402 into N×N data array 410. Knowing the manner used by transmitter controller 420 to write each dataword 402 into N×N data array allows receiving controller 460 to reproduce the correct sequence of bits in each dataword 402 that is transmitted to the receiving device as well as the sequence in which each dataword 402 was sent by the transmitting device to the transmitter controller 420.

Further, analyzing the data loaded in N×N data array 410 may include determining whether encoding the data using an encoding algorithm may reduce or further reduce the number of bit transitions in the wires of bus interconnect 320 of FIG. 3. The data may be encoded using any encoding algorithm, including Gray coding, bus invert (BI) coding etc. Gray coding is a binary numeral system where two successive signal values differ in only one bit (a binary digit). BI coding is a method in which a decision is made at each transmission cycle whether to transfer the true or the complement value of the signals in order to reduce signal toggling on the bus. When using BI coding, transmitter controller 420 may use control signal line 422 to indicate to receiver controller 460 whether the true value or the complement value of dataword 432 is being transferred. For example, transmitter controller 420 will notify receiver controller 460 that the data in N×N data array 410 is being transferred one column or one row at a time before beginning to transfer the data and the transmitter controller 420 may indicate whether BI coding is used by providing a bit on control signal line 422 during each dataword 432 transmission. The bit can be set to 1 whenever BI coding is used (the inverse value of the signal is sent) and 0 otherwise. Alternatively, we can toggle the bit every time the decision of using BI coding changes. Doing so may reduce signal toggling on control signal line 422 while indicating to the receiver controller 460 whether or not BI encoding has been applied to the dataword 432. In another configuration, we may add another control signal to mark the row/column status while signal line 422 indicates a secondary encoding method (Gray or BI coding, etc.). This would eliminate the bandwidth loss due to dual use of control signal 422 (first for row/column transfer and then for secondary encoding). In any case, indicating whether BI encoding is used allows receiving controller 460 to accurately load dataword 432 in N×N data array 450.

As can be inferred from the discussion above, control signal line 422 may be considered a part of the bus interconnect 320. Consequently, in determining the mode in which data from N×N data array 410 is to be transferred, data value(s) that will be sent to receiving controller 460 over control signal line 422 may also be taken into consideration. Further, although control signal line 422 is used as a notification means (i.e., to notify receiver controller 460 whether the data is being transmitted one row or column at a time, or whether the true value or the complement value of the data is being transmitted etc.), control signal line 422 is not required. That is, any means of making receiver controller 460 aware of how the data is transferred from N×N data array 410 may be used and is within the scope of the disclosure.

In certain computing environments, input and output buffers 312, 318, 342 and 348 may be configured as three-dimensional (3D) or N×N×N buffer arrays instead of two-dimensional (2D) or N×N buffer arrays, where N, as before, may be any positive integer. FIG. 4(b) depicts a block diagram of a transmitter controller 420 using an N×N×N buffer array 410 to transmit data to a receiver controller 460 in the computing system of FIG. 1. N×N×N data array 410 includes an x-plane, a y-plane and a z-plane. Likewise, N×N×N data array 450 includes an x-plane, a y-plane and a z-plane. As before, transmitter controller 420 and receiver controller 460 may write data into N×N×N data array 410 and into N×N×N data array 450 in a default manner (e.g., from top-to-bottom in x-plane, or left-to-write in y-plane etc.). After filling up N×N×N data array 410, transmitter controller 420 may analyze the data to determine whether to transmit the data from the x-plane, y-plane or z-plane of the N×N×N data array 410. Depending on the result, transmitter controller 420 may use line 412 to load data from the x-plane of the N×N×N data array 410 into multiplexer 430 and receiver controller 460 may use line 442 to write data from demultiplexer 440 into the x-plane of N×N×N data array 450 (i.e., when transmitting data from the x-plane of N×N×N data array 410 yields the least amount of dynamic power consumption). Alternatively, transmitter controller 420 may use line 414 to load data from the y-plane of the N×N×N data array 410 into multiplexer 430 and receiver controller 460 may use line 442 to write data from demultiplexer 440 into the y-plane of N×N×N data array 450 when transmitting data from the y-plane of N×N×N data array 410 yields the least amount of dynamic power consumption. Or, transmitter controller may use line 416 to load data from the z-plane of the N×N×N data array 410 into multiplexer 430 and receiver controller 460 may use line 442 to write data from demultiplexer 440 into the z-plane of N×N×N data array 450 when transmitting data from the z-plane of N×N×N data array 410 yields the least amount of dynamic power consumption. In any case, control signal 422, which in this instance may consist of two wires, is used to indicate the plane (x, y or z) being used to transmit each N-bit dataword 432. As an example, a “01” value on control signal line 422 may indicate that the N-bit datawords 432 are from the x-plane, a “10” value may indicate the y-plane, and a “11” value may indicate the z-plane.

Note that in FIG. 3, interconnect bus 320 is shown as being an off-chip bus (i.e., connecting APU 102 to I/O hub 120 of FIG. 1). However, the disclosure is not limited to interconnect bus 320 being an off-chip bus. Interconnect bus 320 may be an on-chip bus (i.e., between two different functional blocks of a system-on-chip (SoC) device). For example, interconnect bus 320 may be between a first level cache (i.e., L1 cache) and a second level cache (i.e., L2 cache) integrated in APU 102. Therefore, the depicted example in FIG. 3 is not meant to imply any architectural limitations.

In other computing environments, N of the N×N (i.e., 2D) or of the N×N×N (i.e., 3D) input and output buffers 410 and 450 may be a multiple of the number of wires in the unidirectional links 322 and 324 of bus interconnect 320 of FIG. 3. In such instances, each dataword 402 may continue to be as large as possible to fit in the rows or columns of the input buffer 410. However, each dataword 432 may only be as large as the number of wires in each of the unidirectional links of bus interconnect 320. Consequently, transferring each row or column of input buffer 410 may include transferring a plurality of datawords 432 to receiving controller 460.

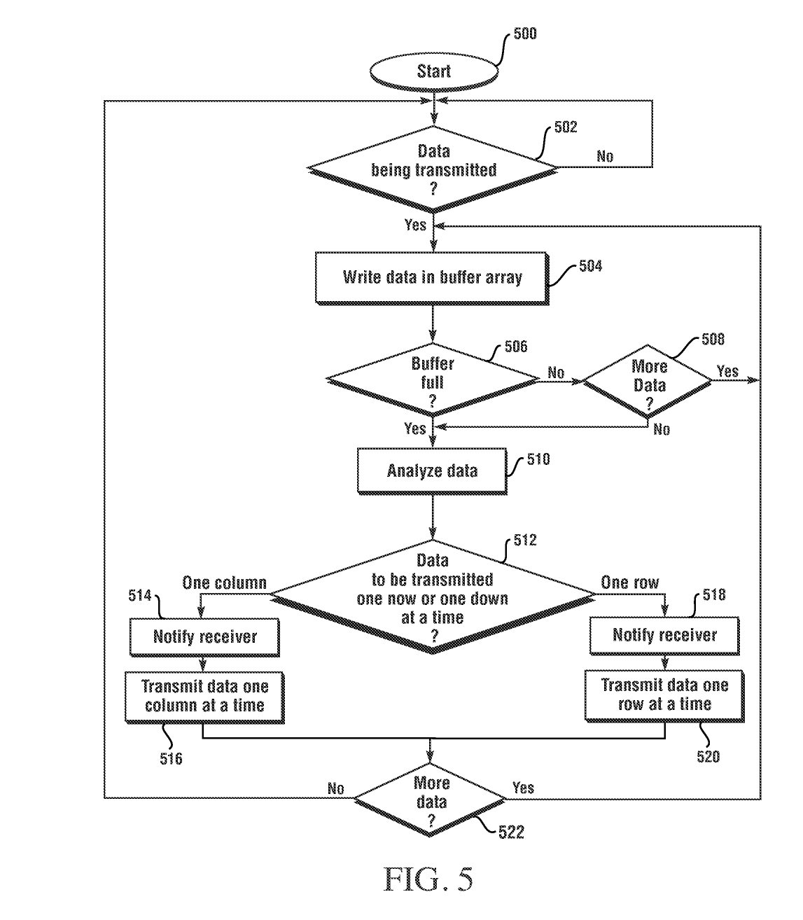

FIG. 5 depicts a flow diagram of a process that may be used by a transmitter of a controller servicing a transmitting device to transmit data to a receiver of a controller servicing a receiving device of the computing system 100, according to some embodiments. The process starts at box 500 when the computing system 100 is turned on or rebooted. Upon the computing system 100 being up and running, the transmitter controller determines in decision box 502 whether the transmitting device is transmitting data. If not, the process remains at decision box 502. If the transmitting device is transmitting data, the transmitter controller writes the data in a buffer configured either as a two-dimensional (2D) array or a three-dimensional (3D) array at box 504. At decision box 506, the transmitter controller determines whether the buffer is full. If the buffer is not yet full, the transmitter controller determines at decision box 508 whether more data is being transmitted by the transmitting device. If so, the process returns to box 504 where the data being transmitted is written into the buffer.

If the transmitter controller determines at decision box 506 that the buffer is full or determines at decision box 508 that there is not anymore data being transmitted by the transmitting device, the transmitter controller analyzes the data in the buffer at box 510 to determine whether, when the buffer is configured as a 2D array, transmitting the data from the buffer to the receiver controller one row or one column at a time will result in the least amount of dynamic power consumption (see decision box 512). In the case where the buffer is configured as a 3D array, the transmitter controller analyzes the data at decision at box 512 to determine whether transmitting the data from plane x, y or z of the 3D array will result in the least amount of dynamic power consumption.

In analyzing the data, the transmitter controller may apply any sort of encoding to the data in the buffer that may help in reducing the amount of dynamic power that may be consumed to transmit the data. For example, the transmitter controller may decide to use Gray coding, BI coding and/or any other encoding algorithm to the data, so long as the encoding(s) used will reduce or further reduce the number of signal transitions in the bus while the data is being transmitted. In any case, if transmitting the data one row at time will result in the least amount of dynamic power consumption, the transmitter controller will notify the receiver controller that the data will be transmitted one row at a time at box 518 and transmits the data one row at a time at box 520. The transmitter controller will also notify the receiver controller whether any encoding is applied to the data before or while the data is being transmitted.

If, on the other hand, transmitting the data one column at time will result in the least amount of dynamic power consumption, the transmitter controller will notify the receiver controller that the data will be transmitted one column at a time at box 514 and transmits the data one column at a time at box 516. Again, the transmitter controller will also notify the receiver controller whether any encoding is applied to the data before or while the data is being transmitted.

Likewise, when the buffer is a 3D buffer, if the transmitter controller determines at decision box 512 that transmitting the data using a particular plane will result in the least amount of dynamic power consumption, the transmitter controller will choose to transmit the data to the receiver controller using the particular plane.

At decision box 522, the transmitter will check to see whether more data is being transmitted by the transmitting device. If so, the process returns to box 504 in order to write the additional data in the buffer. If no more data is being transmitted by the transmitting device, the process returns to decision box 502 where the transmitter controller waits for a transmitting device to start transmitting data. The process ends when the computing system 100 is turned off or rebooted.

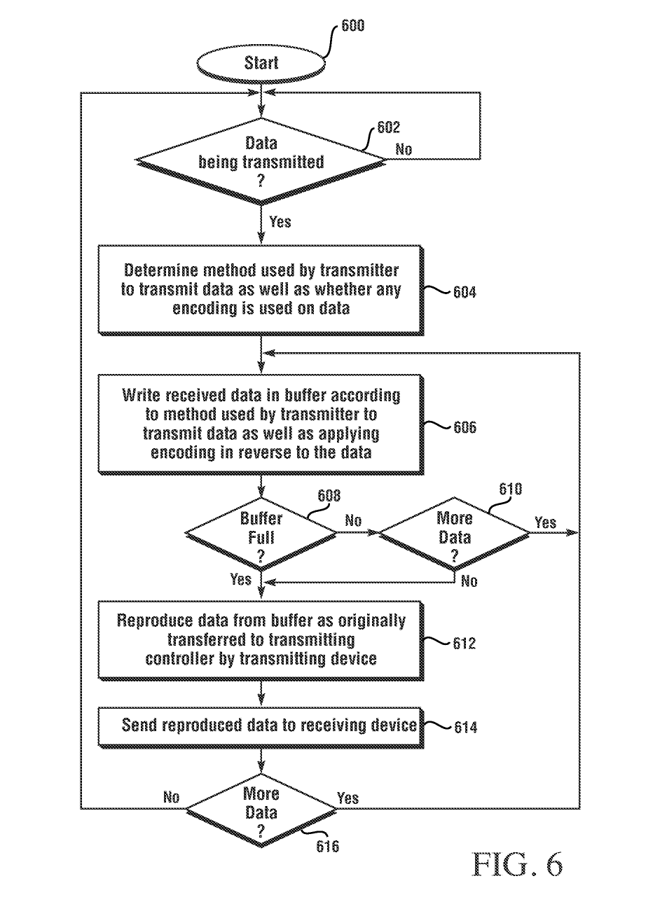

FIG. 6 depicts a flow diagram of a process that may be used by a receiver of a controller servicing a receiving device to reproduce data transmitted by a transmitter of a controller servicing a transmitting device of the computing system 100, according to some embodiments. The process starts at box 600 when the computing system 100 is turned on or rebooted. Upon the computing system 100 being up and running, the receiver controller determines in decision box 602 whether data is being transmitted by the transmitter controller. If not, the process remains at decision box 602. If data is being transmitted, the receiver controller determines the method used by the transmitter controller to transmit the data to the receiver controller as well as whether any encoding algorithm was used to encode the data being transmitted at box 604. Then at box 606, the receiver controller writes the data in a buffer configured in the same manner as that used by the transmitter controller to store the data before sending the data to the receiver controller (i.e., either 2D or 3D). In writing the data, the receiver controller will apply the corresponding decoding algorithm.

At decision box 608, the receiver controller determines whether the buffer is full. If the buffer is not yet full, the receiver controller determines at decision box 610 whether more data is being transmitted by the transmitter controller. If so, the process returns to box 606 where the data being transmitted is written into the buffer.

If the receiver controller determines at decision box 608 that the buffer is full or determines at decision box 610 that there is not anymore data being transmitted by the transmitter controller, then at box 612, the receiver controller reproduces the data as originally transmitted by the transmitting device and sends the reproduced data to the receiving device at box 614.

At decision box 616, the receiver controller checks to see whether more data is being transmitted by the transmitter controller. If so, the process returns to box 604 where the additional data is written into the buffer. If no more data is being transmitted by the transmitting device, the process returns to decision box 602 where the receiver controller waits to receive data from a transmitter controller. The process ends when the computing system 100 is turned off or rebooted.

Some of the functions of APU 102 of FIG. 1 may be implemented with various combinations of hardware, software and/or firmware. Further, some or all of the software components may be stored in a non-transitory computer readable storage medium for execution by at least one processor. In various embodiments, the non-transitory computer readable storage medium includes a magnetic or optical disk storage device, solid-state storage devices such as FLASH memory, or other non-volatile memory device or devices. The computer readable instructions stored on the non-transitory computer readable storage medium may be in source code, assembly language code, object code, or other instruction format that is interpreted and/or executable by one or more processors.

The circuits of FIGS. 1-4(a) and (b) or portions thereof may be described or represented by a computer accessible data structure in the form of a database or other data structure which can be read by a program and used, directly or indirectly, to fabricate integrated circuits with the circuits of FIGS. 1-3. For example, this data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates that also represent the functionality of the hardware comprising integrated circuits with the circuits of FIGS. 1-4(a) and (b). The netlist may then be placed and routed to produce a data set describing geometric shapes to be applied to masks. The masks may then be used in various semiconductor fabrication steps to produce integrated circuits of FIGS. 1-4(a) and (b). Alternatively, the database on the computer accessible storage medium may be the netlist (with or without the synthesis library) or the data set, as desired, or Graphic Data System (GDS) II data.

While particular embodiments have been described, various modifications to these embodiments will be apparent to those skilled in the art. Accordingly, it is intended by the appended claims to cover all modifications of the disclosed embodiments that fall within the scope of the disclosed embodiments.

1. A method of reducing power consumption in a bus interconnect comprising:
analyzing data stored in the a two-dimensional (2D) buffer array for transmission over the bus interconnect to determine a mode of transmitting the stored data, the determined mode being a mode using a least amount of power to transmit the stored data; and
transmitting the stored data over the bus interconnect according to the determined mode.

2. The method of claim 1, wherein the determined mode includes transmitting the stored data one column at a time.

3. The method of claim 1, wherein the determined mode includes transmitting the stored data one row at a time.

4. The method of claim 1, wherein the stored data is encoded using an encoding algorithm.

5. The method of claim 1, wherein the buffer is configured as a three-dimensional (3D) buffer array having three planes, wherein the determined mode includes transmitting the stored data in the 3D buffer array from one plane of the three planes, the one plane being a plane using the least amount of power to transmit the data.

6. A circuit comprising:
a buffer for storing data; and
a controller, wherein the controller:
analyzes N bits data chunks to determine a mode of transmitting the data in the buffer that uses a least amount of power; and
transmits the data in the buffer according to the determined mode.

7. The circuit of claim 6, wherein the controller configures the buffer into an N×N buffer array.

8. The circuit of claim 7, wherein the determined mode includes transmitting the data in the N×N buffer array one column at a time.

9. The circuit of claim 7, wherein the determined mode includes transmitting the data in the N×N buffer array one row at a time.

10. The circuit of claim 6, wherein analyzing the N bits data chunks includes determining whether to encode the N bits data chunks using an encoding algorithm.

11. The circuit of claim 10, wherein the N bits chunks of data is encoded using the encoding algorithm.

12. The circuit of claim 6, further comprising a control data line, wherein the controller uses the control data line to notify a receiving circuit of the determined mode of transmitting the data.

13. The circuit of claim 12, wherein a command bus comprises the control data line.

14. The circuit of claim 6, wherein the data is transmitted over an interconnect bus to a receiving circuit, wherein the buffer and the controller are included in a first integrated circuit and the receiving circuit is included in a second integrated circuit.

15. The circuit of claim 14, wherein the buffer, the controller and the receiving circuit are included in an integrated circuit.

16. The circuit of claim 6, wherein the circuit is in a data processing device.

17. The circuit of claim 6, wherein the circuit is in a memory device.

18. A circuit comprising:
a two-dimensional (2D) buffer array for storing data;
a data control line; and
a controller, wherein the controller:
analyzes data in the 2D buffer array to determine a mode of transmitting the data to the receiving circuit that uses a least amount of power;
transmits the data in the 2D buffer array to the receiving circuit according to the determined mode; and
notifies the receiving circuit of the determined mode of transmitting the data using the data control line.

19. The circuit of claim 18, wherein the buffer and the controller are in a first integrated circuit and the receiving circuit is in a second integrated circuit.

20. The circuit of claim 18, wherein the buffer, the controller and the receiving circuit are in an integrated circuit.

21. The method of claim 1, further comprising:
configuring a buffer as the 2D buffer array having a plurality of rows and columns; and
storing data to be transmitted over the bus interconnect into the buffer.

22. The circuit of claim 6, wherein the controller further:
stores data to be transmitted in the buffer; and
divides the data in the buffer into a plurality of the N bits data chunks, N being an integer.

23. The circuit of claim 18, wherein the controller further:
configures a buffer as the 2D buffer array; and
stores data to be transmitted to a receiving circuit in the 2D buffer array.
